(19) United States
(12) Patent Application Publication
(10) Pub. No.: US 2014/0084498 A1
(43) Pub. Date: Mar. 27, 2014

(54) LENS WITH FILTER AND METHOD OF MANUFACTURING THEREOF

(71) Applicant: Kuo-Ching CHIANG, New Taipei City (TW)

(72) Inventor: Kuo-Ching CHIANG, New Taipei City (TW)

(21) Appl. No.: 13/624,918

(22) Filed: Sep. 22, 2012

(51) Int. Cl. B29D 11/00

(52) U.S. Cl. 264/1.1

(57) ABSTRACT

A method of forming an optical plastic lens includes prepare an molding material and thermal color-changeable or photo color-changeable material; the thermal color-changeable or photo color-changeable material is mixed into the molding material when the molding process is performed to allow the thermal color-changeable or photo color-changeable material exist in the plastic lens uniformly to change the color under photo change or thermal change.

### TECHNICAL FIELD

The present invention generally relates to lens with color changeable filter.

### DESCRIPTION OF THE RELATED ART

FIG. 2 is typical image sensor and the lens, in which includes lens set 200 having pluralities of lens, a filter 210 formed before the lens and the image sensor 220. The filter is independent substrate coated with filter. The independent filter 210 has a thickness, therefore, it is unlikely to reduce the thickness of the mobile phone or the IP CAM lens. Therefore, most of the lens sets for the mobile phone remove the filter to reduce the thickness of the phone, however, the image quality is reduced due to much IR or UV is detected by the sensor. Further, most of the glass lens with filter, the filter is formed by coating, the process required spin coater, and the surface might be scratched to impact the film on the glass lens.

### SUMMARY

The present invention provides a method of forming color change lens, comprising preparing molding base material and preparing color changeable material; mixing said molding base material and said color changeable material with a weight percentage ratio; loading said mixed molding base material and said color changeable material into a molding apparatus; forming lens by molding process by said molding apparatus with a temperature, wherein said lens is color changeable when sunlight irradiates on said lens.

If the color changeable material includes photochromic or thermal-chromic dye, the molding process includes injection molding, extrusion molding and the molding temperature is below dissociation temperature of said photochromic or thermal-chromic dye, a molding temperature is about 180-200 [symbol] 200-220 [symbol] 220-230 [symbol] 230-250° C., and said molding base material is PC or PMMA.

If the color changeable material includes silver halide and copper oxide, the silver halide includes silver bromide, silver chloride or the combination. The molding process includes injection molding or extrusion molding. The molding temperature is about 180-200 [symbol] 200-220 [symbol] 220-230 [symbol] 230-250, 250-280, 280-300° C. The molding base material is PC or PMMA. If the color changeable material includes titanium dioxide doped with silver, the molding process includes injection molding or extrusion molding. The molding temperature is about 180-200 [symbol] 200-220 [symbol] 220-230 [symbol] 230-250, 250-280, 280-300° C.

### BRIEF DESCRIPTION OF THE DRAWINGS

FIG. 1 shows the diagram of the present invention.

FIG. 2 shows the prior art.

FIG. 3 shows the embodiment of the present invention.

FIG. 4 shows the embodiment of the present invention.

FIG. 5 shows the embodiment of the present invention before exposing under sunlight.

FIG. 6 shows the embodiment of the present invention after exposing under sunlight.

### DETAILED DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a digital photo frame, or a notebook, etc. The following embodiment is just to illustrate rather than limiting the present invention.

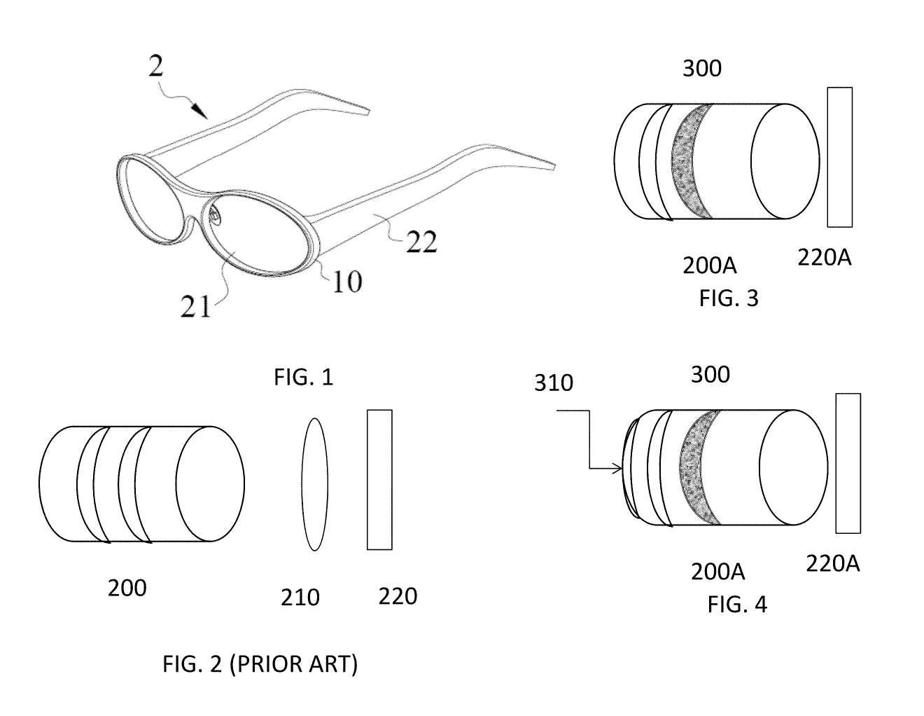

FIG. 1 exhibits a glasses 2 including main frame 2, lens frame 10 to support the lens 21. Some of the glasses remove the lens frame 10. The lens of the present invention is formed with color-changeable material. The prior art uses the coating method to form a film on the surface of the lens, however, the present invention omits the coating process to reduce the cost. The present invention uses injection molding, extrusion molding to form the plastic lens.

The photochromic (or thermal-chromic) dye is sensitive to the ultra-ray, when the photochromic dye is irradiated by the sunlight, the material will change it color due to the chemical structure is change. Therefore, the present invention will add the photochromic or thermal-chromic dye during the injection molding, extrusion mold process, and optionally, the stabilizers, UV absorbers or antioxidants may be added during the injection molding, extrusion mold process. The photochromic dye may be spiropyrans [symbol] spiroxazines [symbol] fulgide [symbol] fulgimides [symbol] benzopyran [symbol] naphthopyran [symbol] spirobenzopyran [symbol] spironaphthopyran [symbol] spirobenzoxazine or spironaphthoxazine∘

The weight percentage of the photochromic dye is about 0.01%˜0.3%. The process temperature during the injection is preferably under 260° C. to prevent the chemical structure of the photochromic dye from being dissociation. If the system uses the PMMA as the base material, the temperature of the injection is below 230° C., preferably, 180-200° C. If PC is the base material, the temperature of the injection is below 250° C., preferably, 220-245° C. ARTON with better birefringence could be used as well.

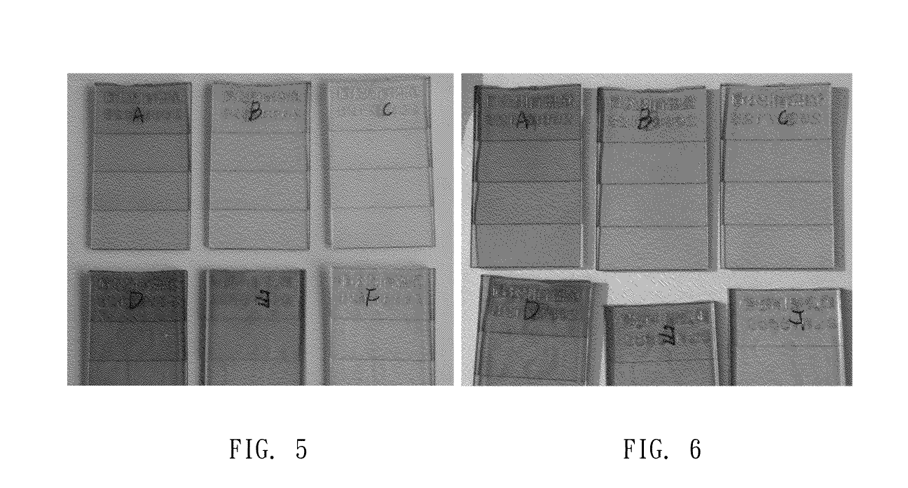

Please refer to FIG. 5, the samples No. 1-No. 3 are in the first row from right to left, the weight percentage is one time, two times to four times, temperature of the injection is around 200-220° C. The samples No. 4-No. 6 are in the second row from right to left, the weight percentage is one time, two times to four times, temperature of the injection is around 220-240° C. The pictures are taken in house. After the samples are exposed by the sun with five seconds, the samples are already change color. The temperature of the injection may be 180-200 [symbol] 200-220 [symbol] 220-230 [symbol] 230-250° C. The base material should be dried with 1-5 hours depending on the quantity. Then, the dried based material is mixed with the photochromic dye by certain ratio. The ratio and the process temperature will affect the result of the color change. Further, the uppermost of the injection process temperature should be lower than the dissociation temperature of the dye. Further, the silver halide may be used alone or mixed with the photochromic dye to achieve the color change effect, in the embodiment, copper oxide maybe added during the process. temperature of the injection may be, 220-250, 250-280° C. . In another embodiment, titanium dioxide with silver may be used with the PMMA or PC to form the color change lens by the above injection or extrusion molding. The weight percentage is almost the same with the dye. The size of the particles may be 200-1000 nanometers. Nano-sized Ag deposits were formed on two commercial TiO₂ nanopowders. Under the sunlight the titanium dioxide with doped silver may change color due to the silver may catch or loss the electrons. The titanium dioxide with doped silver may be used to eliminate the bacteria on the lens, simultaneously. Preferably, the titanium dioxide may be formed on the lens surface by immersion on the solution of titanium dioxide with doped silver. Nano-sized Ag deposits were formed on two commercial TiO₂ nanopowders using a photochemical reduction method. The inactivation kinetics of nAg/TiO₂ was compared to the base TiO₂ material and silver ions leached from the catalyst. The increased production of hydroxyl free radicals is responsible for the enhanced viral inactivation.

If the present invention is introduced into the image sensor module, the lens with anti-UV or anti-IR may be formed by the above method. Therefore, the traditional independent IR cut off cart will removed by the present invention, please refer to FIG. 3, the IR cut off card or anti-UV film will be integrated into one lens. The module includes lens 200A, an image sensor 220A is located behind of the lens. It is apparently, the present invention omits the IR cut off cart but with the function of IR cut-off due to the anti-IR material such as IR absorption material is mixed into the lens by injection. At least one lens 300 includes the IR absorption material mixed in the PC or PMMA. Therefore, the present invention may reduce the thickness of the lens set with IR or UV cut function to improve the quality with thinner thickness. Other embodiment is that the UV absorption material is mixed in the PC or PMMA by the aforementioned method to filter out the UV ray. The above method could be used for helmet wind shade, plastic shade, plastic window.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A method of forming color change lens, comprising:
preparing molding base material and preparing color changeable material;
mixing said molding base material and said color changeable material with a weight percentage ratio;
loading said mixed molding base material and said color changeable material into a molding apparatus;
forming lens by molding process by said molding apparatus with a temperature, wherein said lens is color changeable when sunlight irradiates on said lens.

2. The method according to claim 1, wherein said color changeable material includes photochromic or thermal-chromic dye.

3. The method according to claim 2, wherein said molding process includes injection molding, extrusion molding.

4. The method to claim 3, wherein a molding temperature is below dissociation temperature of said photochromic or thermal-chromic dye.

5. The method according to claim 2, a molding temperature is about 180-200 [symbol] 200-220 [symbol] 220-230 [symbol] 230-250° C., and said molding base material is PC or PMMA.

6. The method according to claim 1, wherein said color changeable material includes silver halide and copper oxide.

7. The method according to claim 1, wherein said silver halide includes silver bromide, silver chloride or the combination.

8. The method according to claim 7, wherein said molding process includes injection molding, extrusion molding.

9. The method according to claim 8, wherein a molding temperature is about 180-200 [symbol] 200-220 [symbol] 220-230 [symbol] 230-250, 250-280, 280-300° C.

10. The method according to claim 8, wherein said molding base material is PC or PMMA.

11. The method according to claim 1, wherein said color changeable material includes titanium dioxide doped with silver.

12. The method according to claim 11, wherein said molding process includes injection molding or extrusion molding.

13. The method according to claim 12, wherein a molding temperature is about 180-200 [symbol] 200-220 [symbol] 220-230 [symbol] 230-250, 250-280, 280-300° C.

14. The method according to claim 11, wherein said molding base material is PC or PMMA.
